(19) United States
(12) Patent Application Publication
(10) Pub. No.: US 2006/0107709 A1
(43) Pub. Date: May 25, 2006

(54) Padlock having an indicator

(76) Inventor: Chun Te Yu, Fusing Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/284,816

(22) Filed: Nov. 23, 2005

(30) Foreign Application Priority Data
Nov. 23, 2004 (TW) 093218813
Apr. 29, 2005 (TW) 094114058
Aug. 22, 2005 (TW) 094128645

(51) Int. Cl. E05B 37/02

(52) U.S. Cl. 70/21; 70/25

(57) ABSTRACT

A padlock can be opened by either one of a key and a code, and includes an indicator. When the padlock is opened by the key, the indicator is moved from a first position to a second position. The indicator is returned to the first position only when the padlock is opened by the code. The indicator has a surface provided with a first mark and a second mark so that when the indicator is disposed at the first position, the first mark is exposed and the second mark is covered by the indicator, and when the indicator is disposed at the second position, the second mark is exposed and the first mark is covered by the indicator. Thus, users can judge by the indicators if their padlocks have been unlocked.

### BACKGROUND OF THE INVENTION

1. Field of the Invention

The present invention relates to a padlock, and more particularly to a padlock having an indicator so as to remind a user if the padlock has been opened by a key.

2. Description of the Related Art

A conventional padlock in accordance with the prior art was disclosed in the U.S. Pat. No. 6,877,345 and comprises a housing, a shackle, a number lock module, a key lock module, and an indicator. The shackle is movably mounted on the housing. The housing has a window for exposing the indicator which presents a first color in the window. When the key lock module is unlocked, the indicator presents a second color in the window so as to remind the user that the key lock module has been operated. When the number lock module is unlocked, the indicator is reset to present the first color in the window. However, the indicator occupies the inner space of the housing, and the window of the housing is too small. In addition, the user has to see the second color in the window so as to understand if the key lock module has been unlocked, so that such a padlock is not available for the blind people, thereby limiting the versatility of the padlock.

Another conventional padlock in accordance with the prior art was disclosed in the U.S. Patent Publication No. 2002/0088256A1 and comprises a shackle 14, a shackle sleeve 96, and a housing to lock an article. However, such a padlock only includes a number lock module without providing a key lock module. In addition, such a padlock is not provided with an indicator.

The closest prior art references of which the applicant is aware are disclosed in U.S. Pat. Nos. 1,597,560, 4,751,830 and 6,539,761, each comprising a housing and a shackle to lock an article.

### SUMMARY OF THE INVENTION

The present invention is to mitigate and/or obviate the disadvantage of the conventional padlock.

The primary objective of the present invention is to provide a padlock that is provided with a limit knob whose movement is controlled by a locking mechanism, so that when the limit knob is moved to an opened position, the shackle is rotatable to detach from the limit knob.

Another objective of the present invention is to provide a padlock, wherein the limit knob is provided with an indicator which is moved with the limit knob from a first position to a second position, so that the user can judge by the indicator, if the padlock has been unlocked.

A further objective of the present invention is to provide a padlock, wherein a user can understand movement of the indicator by touch, so that the padlock is also available for the blind people.

A further objective of the present invention is to provide a padlock, wherein the limit knob has a window, rotation of the limit knob is controlled by a key and the mating key lock module, the indicator is movably mounted in the respective limit knob, the indicator is changed from a first position to a second position by rotation of the limit knob, so that the first color and the second color of the indicator are exposed from the window respectively.

A further objective of the present invention is to provide a padlock, wherein the position of the indicator is changed in a lifting displacement manner or in a rotation displacement manner.

A further objective of the present invention is to provide a padlock, wherein when the indicator is mounted in the limit knob, the indicator will not occupy the inner space of the housing.

A further objective of the present invention is to provide a padlock, wherein when the window is located at the side face of the limit knob, the window is made larger and wider, thereby facilitating the user inspecting movement of the indicator.

A further objective of the present invention is to provide a padlock, wherein when the indicator is mounted outside of the limit knob, the indicator has a better reminding effect, and movement of the indicator is made easier.

In accordance with the present invention, there is provided a padlock, opened by a key and a code, comprising an indicator mounted on the padlock in a movable manner. When the padlock is opened by the key, the indicator is moved from a first position to a second position. The indicator is returned from the second position to the first position only when the padlock is opened by the code. The indicator has a surface provided with a first mark and a second mark so that when the indicator is disposed at the first position, the first mark is exposed and the second mark is covered by the indicator, and when the indicator is disposed at the second position, the second mark is exposed and the first mark is covered by the indicator.

Further benefits and advantages of the present invention will become apparent after a careful reading of the detailed description with appropriate reference to the accompanying drawings.

### BRIEF DESCRIPTION OF THE DRAWINGS

FIG. 1 is a perspective view of a padlock in accordance with the first preferred embodiment of the present invention;

FIG. 2 is a partially exploded perspective view of the padlock as shown in FIG. 1;

FIG. 3 is a partially exploded perspective view of the padlock as shown in FIG. 1;

FIG. 4 is a perspective view of a housing of the padlock as shown in FIG. 1;

FIG. 5 is a plan cross-sectional view of the padlock as shown in FIG. 1;

FIG. 6 is a perspective view of the padlock as shown in FIG. 1;

FIG. 7 is a schematic operational view of the padlock as shown in FIG. 5;

FIG. 8 is a schematic operational view of the padlock as shown in FIG. 6;

FIG. 9 is a schematic operational view of the padlock as shown in FIG. 5;

FIG. 10 is a perspective view of a padlock in accordance with the second preferred embodiment of the present invention;

FIG. 11 is a partially exploded perspective view of the padlock as shown in FIG. 10;

FIG. 12 is a partially exploded perspective view of the padlock as shown in FIG. 10;

FIG. 13 is a perspective view of a housing of the padlock as shown in FIG. 10;

FIG. 14 is a plan cross-sectional view of the padlock as shown in FIG. 10;

FIG. 15 is a schematic operational view of the padlock as shown in FIG. 14;

FIG. 16 is a schematic operational view of the padlock as shown in FIG. 15;

FIG. 17 is a schematic operational view of the padlock as shown in FIG. 16;

FIG. 18 is a perspective view of a padlock in accordance with the third preferred embodiment of the present invention;

FIG. 19 is an exploded perspective view of the padlock as shown in FIG. 18;

FIG. 20 is a plan cross-sectional view of the padlock as shown in FIG. 18;

FIG. 20A is a top plan view of the padlock as shown in FIG. 20;

FIG. 21 is a schematic operational view of the padlock as shown in FIG. 20;

FIG. 21A is a top plan view of the padlock as shown in FIG. 21;

FIG. 22 is a schematic operational view of the padlock as shown in FIG. 18;

FIG. 23 is a schematic operational view of the padlock as shown in FIG. 21;

FIG. 23A is a top plan view of the padlock as shown in FIG. 23;

FIG. 24 is a schematic operational view of the padlock as shown in FIG. 23;

FIG. 25 is a plan cross-sectional view of a padlock in accordance with the fourth preferred embodiment of the present invention;

FIG. 25A is a side plan cross-sectional view of the padlock as shown in FIG. 25;

FIG. 25B is a top plan view of the padlock as shown in FIG. 25;

FIG. 26 is a schematic operational view of the padlock as shown in FIG. 25;

FIG. 26A is a top plan view of the padlock as shown in FIG. 26;

FIG. 27 is a schematic operational view of the padlock as shown in FIG. 26;

FIG. 28 is an exploded perspective view of a catch member and an indicator of a padlock in accordance with the fifth preferred embodiment of the present invention;

FIG. 29 is a schematic operational view of a padlock in accordance with the sixth preferred embodiment of the present invention;

FIG. 30 is a schematic operational view of the padlock as shown in FIG. 29;

FIGS. 31 and 32 are perspective views of a padlock in accordance with the seventh preferred embodiment of the present invention;

FIG. 33 is a perspective view of a padlock in accordance with the eighth preferred embodiment of the present invention;

FIG. 34 is a perspective view of a padlock in accordance with the ninth preferred embodiment of the present invention;

FIGS. 35-37 are plan views of a padlock in accordance with the tenth preferred embodiment of the present invention;

FIG. 38 is a plan view of a padlock in accordance with the eleventh preferred embodiment of the present invention;

FIG. 39 is a perspective view of a padlock in accordance with the twelfth preferred embodiment of the present invention;

FIG. 40 is a plan view of the padlock as shown in FIG. 39;

FIG. 41 is a plan view of a padlock in accordance with the thirteenth preferred embodiment of the present invention; and

FIG. 42 is a plan view of a padlock in accordance with the fourteenth preferred embodiment of the present invention.

### DETAILED DESCRIPTION OF THE INVENTION

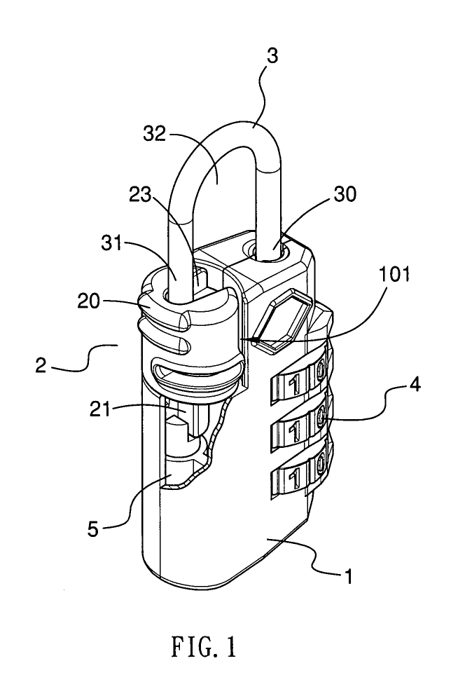

Referring to FIGS. 1-9 and initially to FIGS. 1-3, a padlock in accordance with the first preferred embodiment of the present invention comprises a housing 1, a catch member 2, a shackle 3, a locking mechanism, and an indicator 6.

The catch member 2 is mounted on the housing 1 and includes a limit knob 20 and a base portion 21 extended from the bottom face of the limit knob 20 into the housing 1 to form a movable connection with the housing 1.

The shackle 3 includes a root section 30 extended into the housing 1 to form a movable connection with the housing 1, and a free section 31 having a first end extended from the root section 30 and a second end entered into the limit knob 20, thereby forming a closed zone 32 therebetween.

The locking mechanism is mounted in the housing 1 and includes a number lock module 4 and a key lock module 5.

The number lock module 4 is connected with the root section 30 of the shackle 3 and arranged to allow rotation of the root section 30 of the shackle 3. In addition, when the number lock module 4 is disposed at an unlocked state (e.g. a set of unlocking codes of the number lock module is dialed), the number lock module 4 allows the shackle 3 to move with displacement of the root section 30. In other words, when the number lock module 4 is unlocked, the root section 30 of the shackle 3 is movable upwardly and downwardly.

The key lock module 5 is connected with the base portion 21 of the catch member 2 and driven by a specified key which is rotated to drive the base portion 21 of the catch member 2 so as to control movement of the catch member 2.

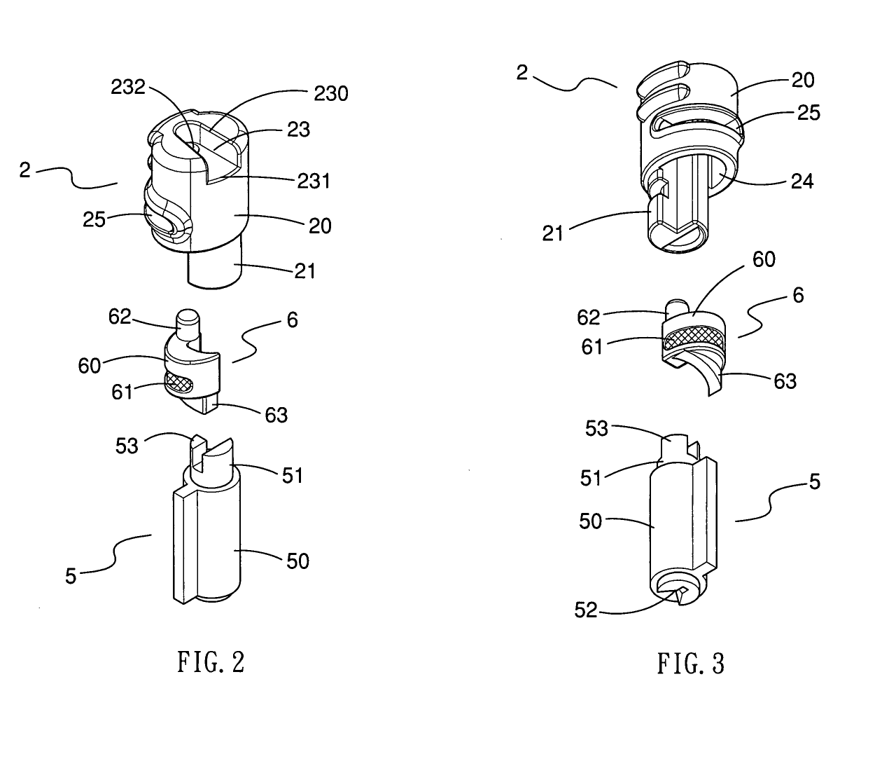

In FIG. 2, the indicator 6 is movably mounted in the limit knob 20 of the catch member 2. The indicator 6 is changed from a first position to a second position according to movement of the limit knob 20 of the catch member 2. In addition, the indicator 6 is returned from the second position to the first position only when the number lock module 4 is disposed at the unlocked state.

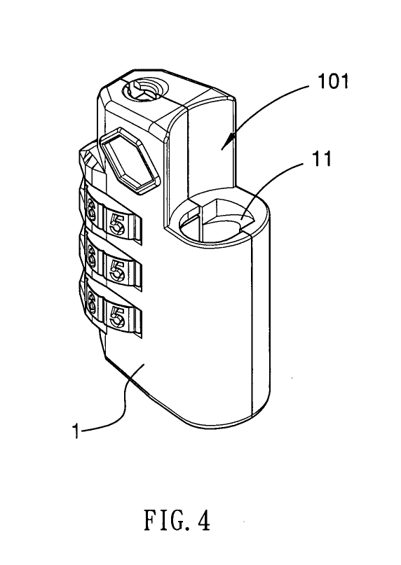

Referring to FIGS. 1-2, the limit knob 20 of the catch member 2 has a receiving recess 23 having a first opening 230 located at a top face of the limit knob 20 and a second opening 231 located at a side face of the limit knob 20 and communicating with the first opening 230. In FIG. 4, the housing 1 has a recessed space 101 to receive the limit knob 20. The space 101 has a height at least equal to that of the limit knob 20 so that the second opening 231 of the limit knob 20 will not expose from the housing 1 to prevent a person from driving the limit knob 20 through the second opening 231 of the limit knob 20.

FIGS. 2 and 3 further show that the limit knob 20 of the catch member 2 has an inside formed with a receiving chamber 24 for receiving the indicator 6 which is movable in the receiving chamber 24. The limit knob 20 of the catch member 2 has a side face formed with a window 25 connected to the receiving chamber 24. The receiving recess 23 of the limit knob 20 has a bottom formed with a setting hole 232 connected to the receiving chamber 24.

The key lock module 5 includes a lock core 50 secured in the housing 1, and a spindle 51 extended through the lock core 50. The spindle 51 has a first end formed with a key slot 52 and a second end formed with a control portion 53 protruding from the lock core 50 and engaged with the base portion 21 of the catch member 2.

The indicator 6 has a first color 60 as a first mark and a second color 61 as a second mark, and has a first side formed with a protruding shaft 62 extended into the setting hole 232 of the limit knob 20 and a second side formed with a guide block 63.

Referring to FIG. 4, the housing 1 has a ramp 11, and the guide block 63 of the indicator 6 is rested on the ramp 11 of the housing 1.

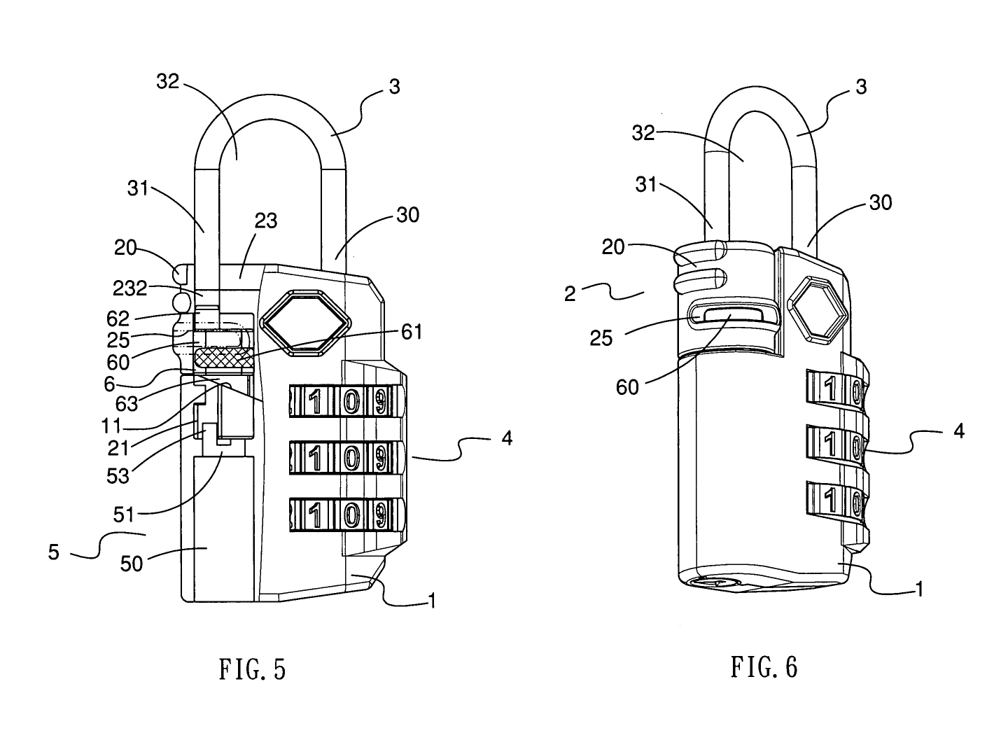

Referring to FIGS. 5-6, when the free section 31 of the shackle 3 is received in the receiving recess 23 of the limit knob 20 that forms the closed zone 32, as a lock status, the setting hole 232 of the limit knob 20 aligns with and faces to the free section 31 of the shackle 3. When the key lock module 5 is not rotated by the specified key, the indicator 6 is disposed at the first position, and the first color 60 of the indicator 6 is exposed from the window 25 of the limit knob 20.

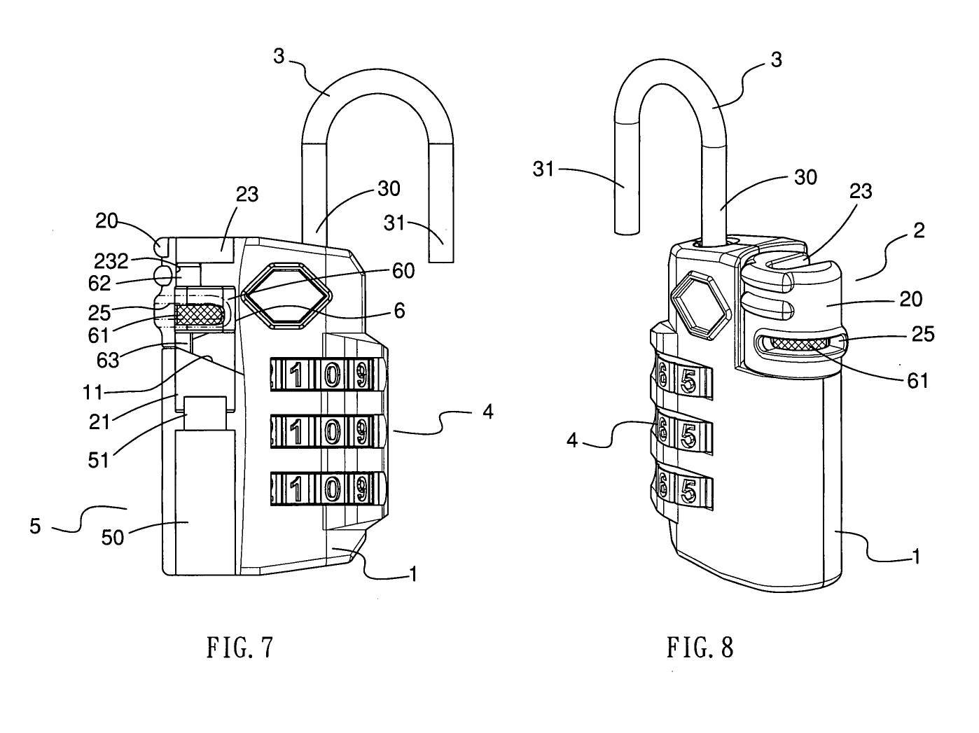

Referring to FIGS. 7 and 8, when the key lock module 5 is rotated by the specified key to drive and to rotate the limit knob 20 to an opened position, the free section 31 of the shackle 3 is rotatable to detach from or to enter into the receiving recess 23 of the limit knob 20. Accordingly, the indicator 6 is rotated with the limit knob 20. Because the guide block 63 of the indicator 6 is rested on the ramp 11 of the housing 1, the indicator 6 is accordingly lifted to the second position, and the second color 61 of the indicator 6 is exposed from the window 25 of the limit knob 20. Thus, the user can judge by the color exposed from the window 25 of the limit knob 20 if the padlock has been unlocked by the specified key.

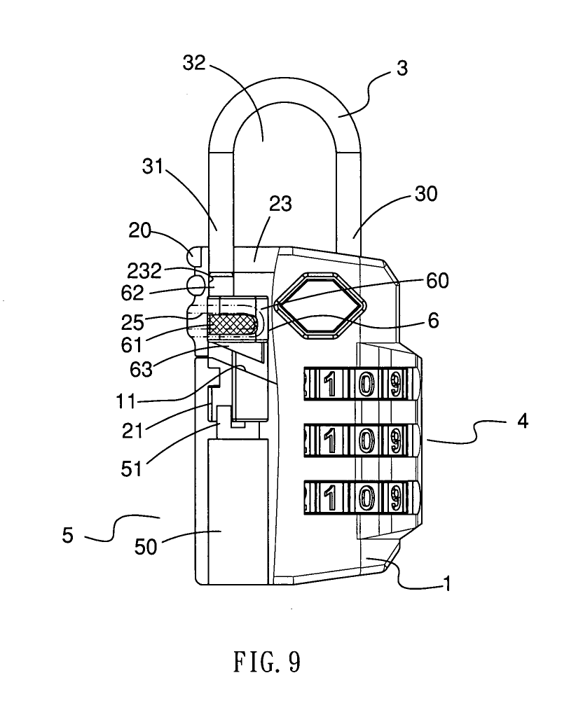

Referring to FIG. 9, when the number lock module 4 is disposed at the unlocked state, the shackle 3 can be lifted to detach the free section 31 of the shackle 3 from the receiving recess 23 of the limit knob 20, and can also be pressed downward to a certain distance so as to change the unlocking code optionally. When the free section 31 of the shackle 3 is detached from the receiving recess 23 of the limit knob 20, the setting hole 232 of the limit knob 20 is exposed. Thus, a tool can be inserted into the setting hole 232 of the limit knob 20 so as to push the protruding shaft 62 of the indicator 6 to have the indicator 6 to return to the first position so that the first color 60 of the indicator 6 is exposed from the window 25 of the limit knob 20. Accordingly, the guide block 63 of the indicator 6 is again rested on the ramp 11 of the housing 1. Alternatively, the shackle 3 can be pressed downward when the free section 31 of the shackle 3 aligns with the setting hole 232 of the limit knob 20, so that the free section 31 of the shackle 3 can be inserted into the setting hole 232 of the limit knob 20 to push the protruding shaft 62 of the indicator 6 to have the indicator 6 to return to the first position.

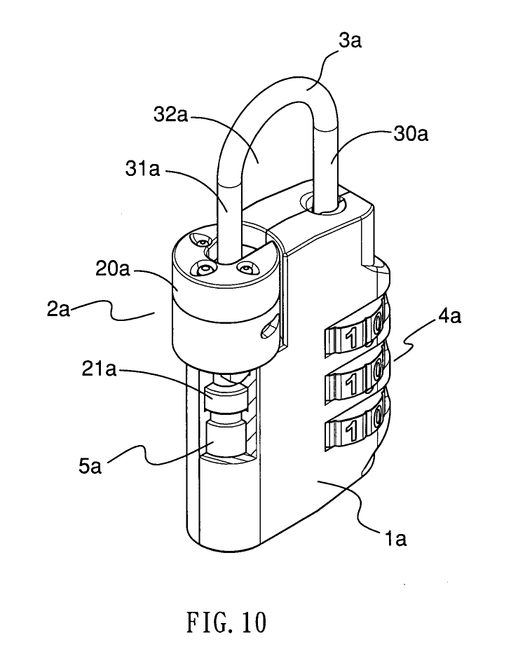

Referring to FIGS. 10-17, a padlock in accordance with the second preferred embodiment of the present invention is similar to that of the first preferred embodiment, wherein the difference is in that when the limit knob 20a of the second preferred embodiment is rotated to an opened position as shown in FIG. 8, the indicator 6a is lifted from the first position to a height lower than that of the second position, so that the second color 61a of the indicator 6a is not exposed from the window 25a of the limit knob 20a, and when the limit knob 20a is rotated from the opened position back to the original position (an original closed position), the indicator 6a is lifted higher successively to the second position, so that the second color 61a of the indicator 6a is exposed from the window 25a of the limit knob 20a accordingly.

In FIG. 10, the catch member 2a is mounted on the housing 1a and includes the limit knob 20a and a base portion 21a. The key lock module 5a is driven by a specified key which is rotated to drive the base portion 21a of the catch member 2a so as to rotate the limit knob 20a of the catch member 2a. The shackle 3a includes a root section 30a extended into the housing 1a to form a movable connection with the housing 1a, and a free section 31a having a first end extended from the root section 30a and a second end entered into the limit knob 20a, thereby forming a closed zone 32a therebetween. The number lock module 4a is used to control axial displacement of the root section 30a of the shackle 3a, similarly to the first preferred embodiment.

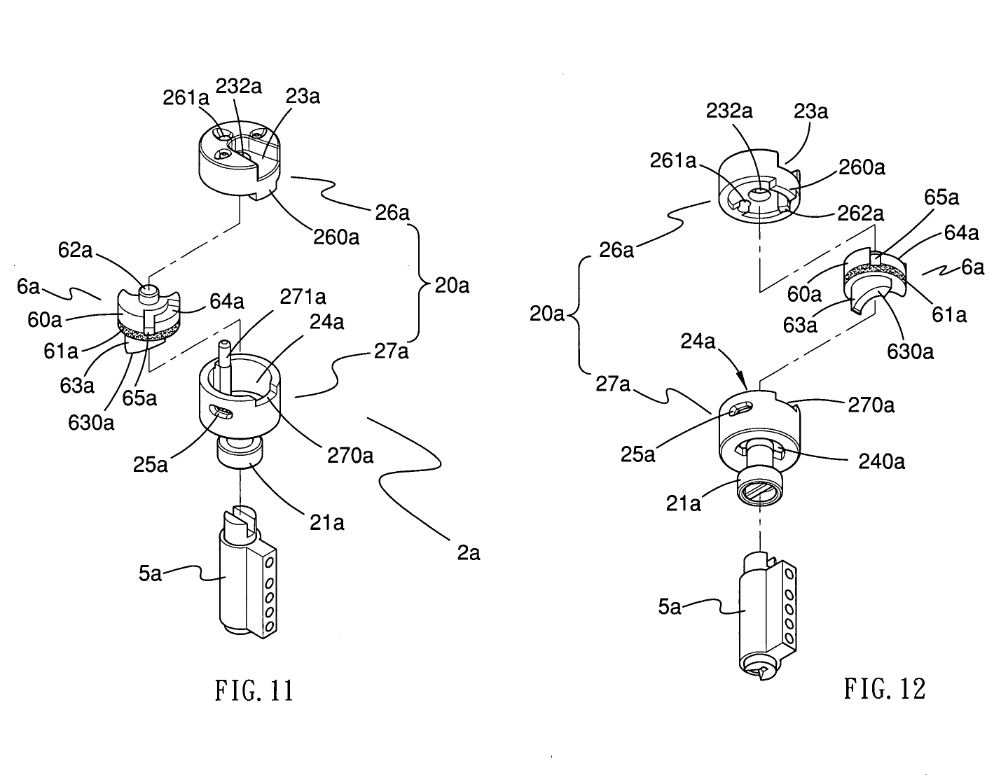

Referring to FIGS. 11 and 12, the limit knob 20a of the catch member 2a includes a limit block 26a and a drive block 27a, and the indicator 6a is mounted in the limit knob 20a of the catch member 2a.

The limit block 26a of the limit knob 20a has a receiving recess 23a located at a top face thereof. The receiving recess 23a of the limit block 26a has a bottom formed with a setting hole 232a. When the free section 31a of the shackle 3a is received in the receiving recess 23a of the limit block 26a, the setting hole 232a of the limit block 26a aligns with the free section 31a of the shackle 3a.

The drive block 27a of the limit knob 20a has an inside formed with a receiving chamber 24a for receiving the indicator 6a. The drive block 27a has a side face formed with a window 25a connected to the receiving chamber 24a.

The indicator 6a has a first color 60a and a second color 61a, namely a first mark and a second mark, and has a first side formed with a protruding shaft 62a extended into the setting hole 232a of the limit block 26a and a second side formed with a guide block 63a.

Additionally, the limit block 26a of the limit knob 20a has a lug 260a and an insertion hole 261a, and the drive block 27a of the limit knob 20a has a recess 270a engaged with the lug 260a of the limit block 26a and an insertion post 271a inserted into the insertion hole 261a of the limit block 26a, so that the drive block 27a is combined with the limit block 26a.

Referring to FIG. 12, the receiving chamber 24a of the drive block 27a has a bottom formed with a curved slot 240a, and the guide block 63a of the indicator 6a is extended through and slidable in the curved slot 240a of the drive block 27a. The guide block 63a of the indicator 6a has a bottom formed with a first ramp 630a. The indicator 6a has an upper side formed with a sector-shaped slideway 64a having an end formed with an insertion groove 65a having a greater depth. The limit block 26a of the limit knob 20a has a bottom formed with a locking block 262a slidable in the slideway 64a of the indicator 6a and inserted into the insertion groove 65a of the indicator 6a.

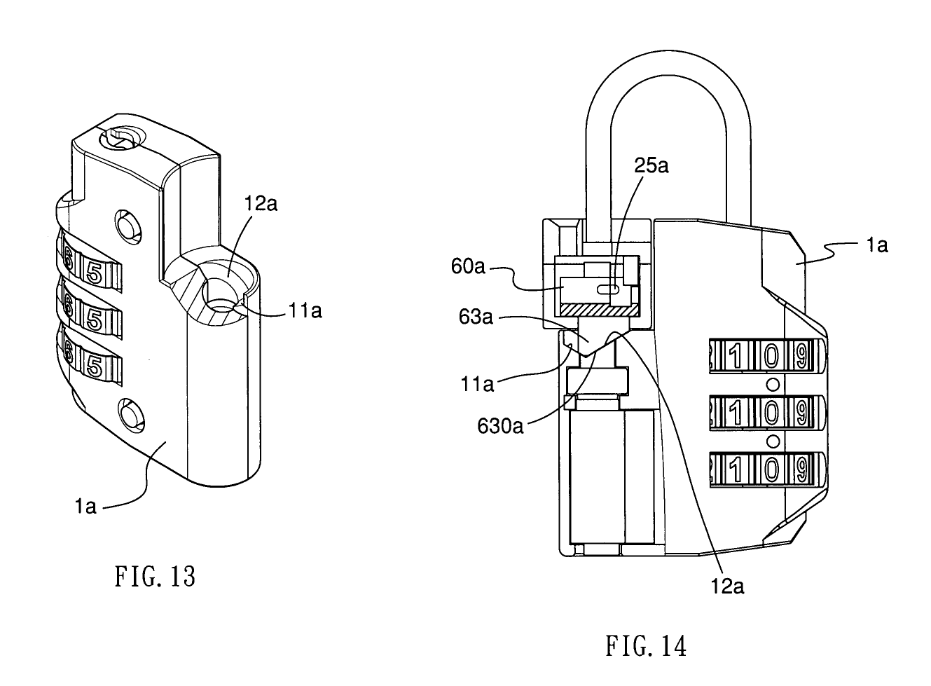

Referring to FIG. 13, the housing 1a has a second ramp 1 1a having a downward oblique end and a third ramp 12a having a downward oblique end connected with the downward oblique end of the second ramp 11a, so that the second ramp 11a and the third ramp 12a form a V-shaped profile. The second ramp 11 a has an outer end lower than an outer end of the third ramp 12a.

Referring to FIG. 14, the indicator 6a is disposed at the first position. Accordingly, the first ramp 630a of the guide block 63a contacts the third ramp 12a of the housing 1a and the first color 60a of the indicator 6a is exposed from the window 25a of the drive block 27a.

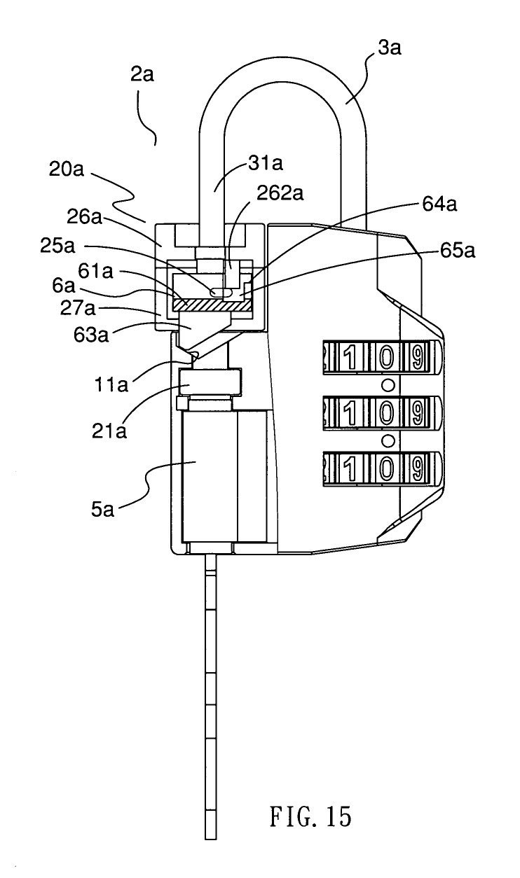

Referring to FIG. 15, when the key lock module 5a is driven by a key to drive the base portion 21a of the catch member 2a to rotate the limit knob 20a of the catch member 2a clockwise, the locking block 262a of the limit block 26a is slidable in the slideway 64a of the indicator 6a, so that the limit block 26a will not drive the indicator 6a to rotate. When the limit knob 20a of the catch member 2a is rotated clockwise through 75 degrees, the locking block 262a of the limit block 26a is moved to abut a side of the slideway 64a of the indicator 6a and located above the insertion groove 65a of the indicator 6a. When the limit knob 20a of the catch member 2a is rotated clockwise successively, the limit block 26a drives the indicator 6a to rotate clockwise. Simultaneously, the bottom of the guide block 63a is slidable on the second ramp 11a of the housing 1a, so that the indicator 6a is lifted to leave the first position, and the limit knob 20a of the catch member 2a is rotated to an opened state, so that the free section 31a of the shackle 3a is rotatable to detach from or to enter into the receiving recess 23a of the limit block 26a, and the locking block 262a of the limit block 26a is locked in the insertion groove 65a of the indicator 6a. At this time, the second color 61a of the indicator 6a is not yet exposed from the window 25a of the drive block 27a.

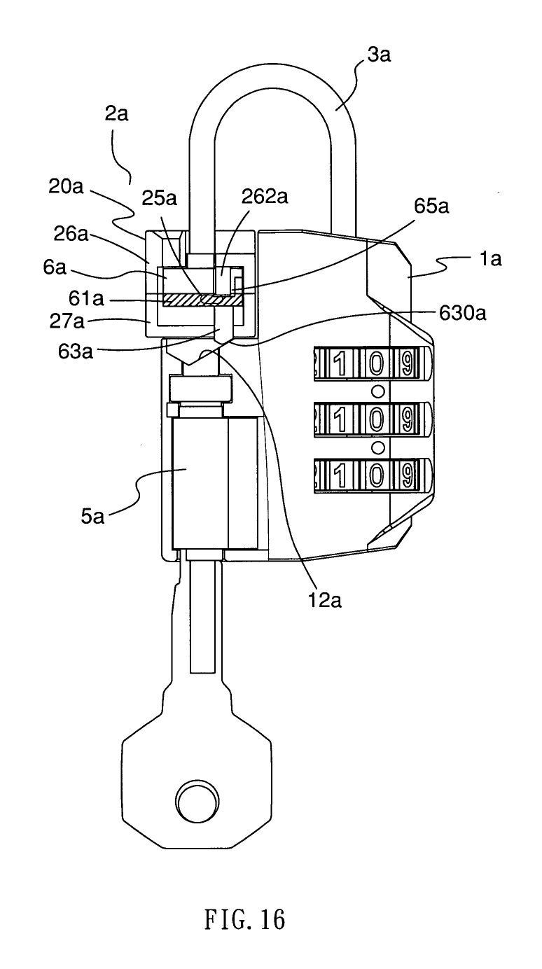

Referring to FIG. 16, when the limit knob 20a of the catch member 2a is rotated counterclockwise by the key lock module 5a and moved from the opened state back to the closed state, the locking block 262a of the limit block 26a which is locked in the insertion groove 65a of the indicator 6a, moves the indicator 6a to rotate counterclockwise accordingly. Thus, the first ramp 630a of the guide block 63a is slidable on the third ramp 12a of the housing 1a, so that the indicator 6a is lifted to the second position, and the second color 61a of the indicator 6a is exposed from the window 25a of the drive block 27a.

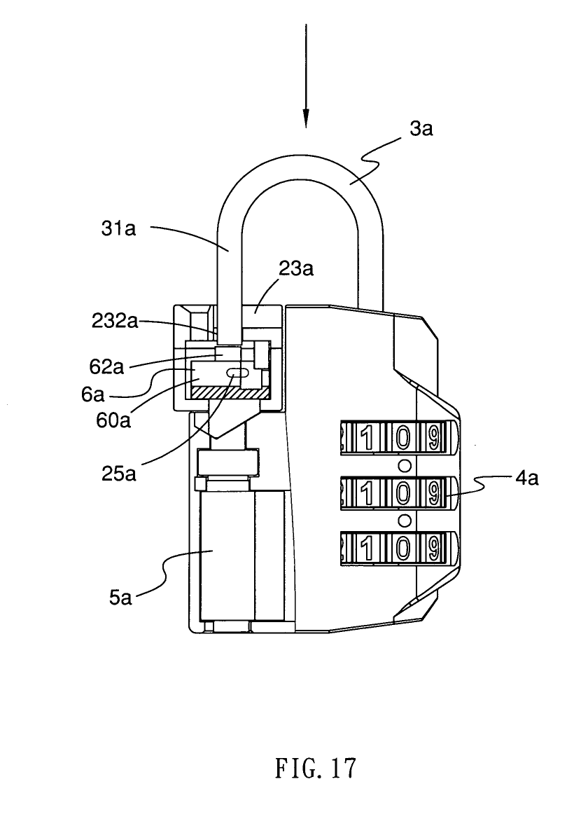

Referring to FIG. 17, when the number lock module 4a is disposed at the unlocked state by dialing a set of unlocking codes, the shackle 3a can be lifted to have the free section 31a of the shackle 3a moved away from the receiving recess 23a, and can also be pressed downward to a certain distance for the purpose of changing the set of unlocking codes. Additionally, when the free section 31a of the shackle 3a is detached from the receiving recess 23a, the setting hole 232a is exposed. Thus, a tool can be extended into the setting hole 232a to push the protruding shaft 62a to drive the indicator 6a to return to the first position so that the first color 60a is exposed from the window 25a. Alternatively, the shackle 3a is pressed downward when the free section 31a of the shackle 3a aligns with the setting hole 232a, so that the free section 31a of the shackle 3a can enter into the setting hole 232a to push the protruding shaft 62a to drive the indicator 6a to return to the first position.

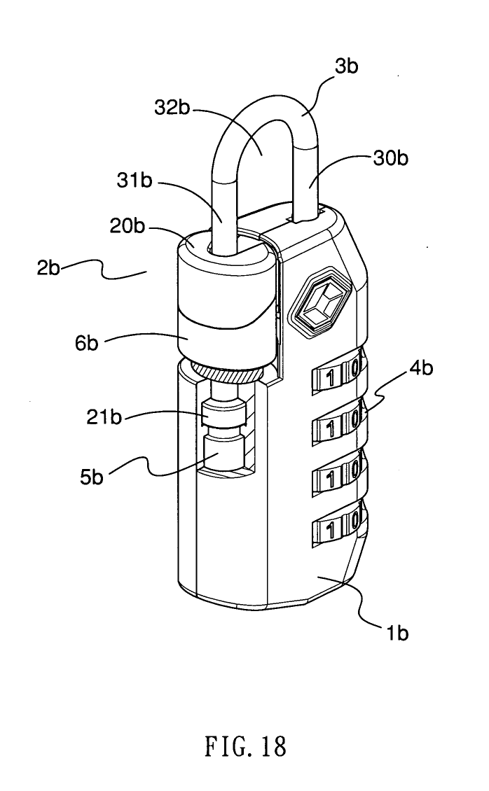

Referring to FIGS. 18-24, a padlock in accordance with the third preferred embodiment of the present invention is similar to that of the first preferred embodiment, wherein the difference is in that when the limit knob 20b of the third preferred embodiment is rotated to an opened position as shown in FIG. 8, the indicator 6b is still not moved, and only when the free section 31b of the shackle 3b is movable from the receiving recess 23b, the free section 31b of the shackle 3b will push the indicator 6b to the second position, so that the second mark 221b is exposed.

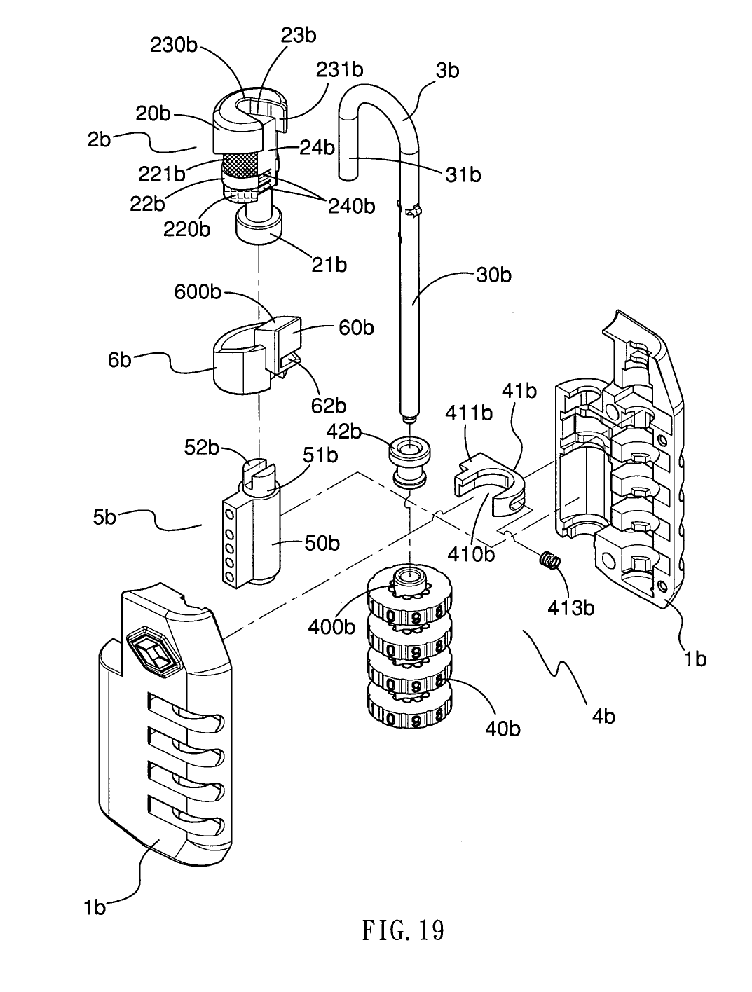

In FIGS. 18-19, the padlock in accordance with the third preferred embodiment of the present invention comprises a housing 1b, a catch member 2b, a shackle 3b, a locking mechanism, and an indicator 6b.

The catch member 2b includes a limit knob 20b and a base portion 21b extended from a bottom face of the limit knob 20b into the housing 1b to form a movable connection with the housing 1b.

The shackle 3b includes a root section 30b extended into the housing 1b to form a movable connection with the housing 1b, and a free section 31b having a first end extended from the root section 30b and a second end entered into the limit knob 20b, thereby forming a closed zone 32b therebetween.

The locking mechanism is mounted in the housing 1b and includes a number lock module 4b and a key lock module 5b.

The number lock module 4b is connected with the root section 30b of the shackle 3b and arranged to allow rotation of the root section 30b of the shackle 3b. In addition, when the number lock module 4b is disposed at the unlocked state, the number lock module 4b allows the shackle 3b to move with displacement of the root section 30b, namely to move axially.

The key lock module 5b is connected with the base portion 21b of the catch member 2b and driven by a specified key which is rotated to drive the base portion 21b of the catch member 2b so as to control movement of the catch member 2b.

Referring to FIG. 19, the limit knob 20b of the catch member 2b has a receiving recess 23b having a first opening 230b located at a top face of the limit knob 20b and a second opening 231b located at a side face of the limit knob 20b. The base portion 21b of the catch member 2b has an exposed section 22b located between the limit knob 20b and the housing 1b. The indicator 6b is movably mounted on an outer face of the exposed section 22b. When the free section 31b of the shackle 3b is rotatable to detach from the limit knob 20b, the indicator 6b is changed from a first position to a second position. In addition, the indicator 6b is returned from the second position to the first position only when the number lock module 4b is disposed at the unlocked state.

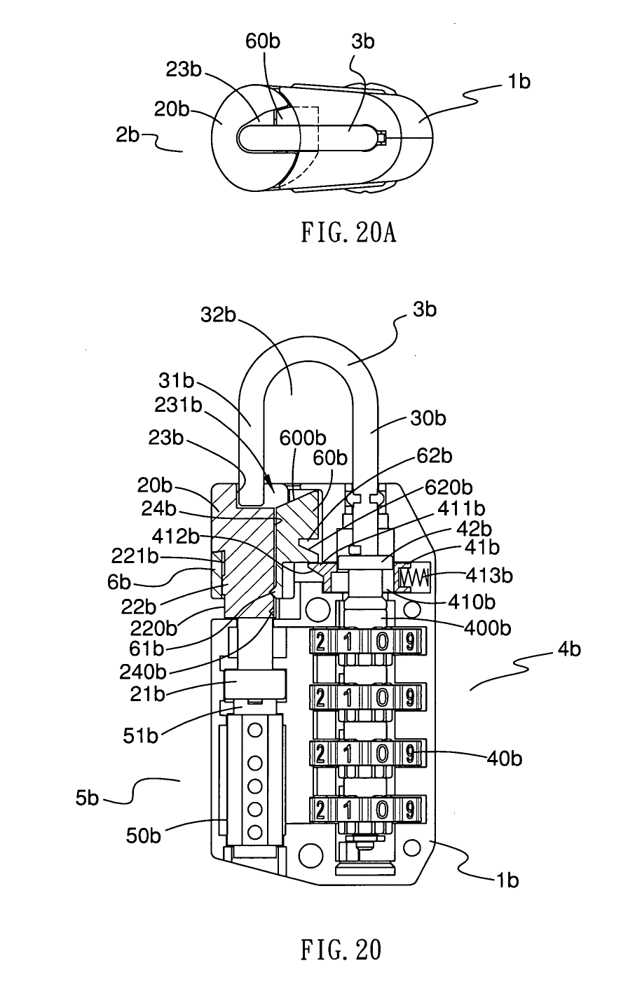

In FIGS. 19, 20 and 20A, the exposed section 22b has a surface formed with a first mark 220b and a second mark 221b, and has a side formed with a slideway 24b extended into the second opening 231b of the limit knob 20b and having two positioning grooves 240b. The indicator 6b has a side formed with a slide 60b and an elastic hook 61b. The slide 60b is slidable in the slideway 24b and has a top formed with a tapered push face 600b inclined toward the second opening 231b of the limit knob 20b and provided for being pushed by the end portion of the free section 31b of the shackle 3b. The elastic hook 61b is hooked in one of the two positioning grooves 240b.

Additionally, the slide 60b has a locking groove 62b having a bottom face formed with a tapered guide face 620b inclined downward.

The number lock module 4b includes a number wheel unit 40b, a locking member 41b, and a limit member 42b. The number wheel unit 40b has a retractable shaft 400b. The locking member 41b has a limit channel 410b and has a first side formed with a protruding latch 411b that can be locked in the locking groove 62b. The protruding latch 411b has a bottom face formed with an oblique face 412b corresponding to the guide face 620b. The locking member 41b has a second side provided with an elastic member 413b located opposite to the protruding latch 411b and urged on the housing 1b. The limit member 42b is mounted on the root section 30b of the shackle 3b. When the number wheel unit 40b is disposed at the locked state to lock the shackle 3b, the limit member 42b is received in the limit channel 410b by limit of the root section 30b of the shackle 3b, so that the locking member 41b is not movable. When the number wheel unit 40b is disposed at the unlocked state to unlock the shackle 3b, the limit member 42b is pushed by the retractable shaft 400b to detach from the limit channel 410b, so that the locking member 41b is movable freely.

The key lock module 5b includes a lock core 50b secured in the housing 1b, and a spindle 51b extended through the lock core 50b. The spindle 51b has an end formed with a control portion 52b protruding from the lock core 50b and engaged with the base portion 21b of the catch member 2.

In FIG. 20, the key lock module 5b is not rotated by a specified key, wherein the indicator 6b is located at the first position, while the protruding latch 411b of the locking member 41b is rested on the bottom of the slide 60b of the indicator 6b, so that the indicator 6b cannot be moved downward. At the time, the first mark 220b is exposed outward and the second mark 221b is covered by the indicator 6b.

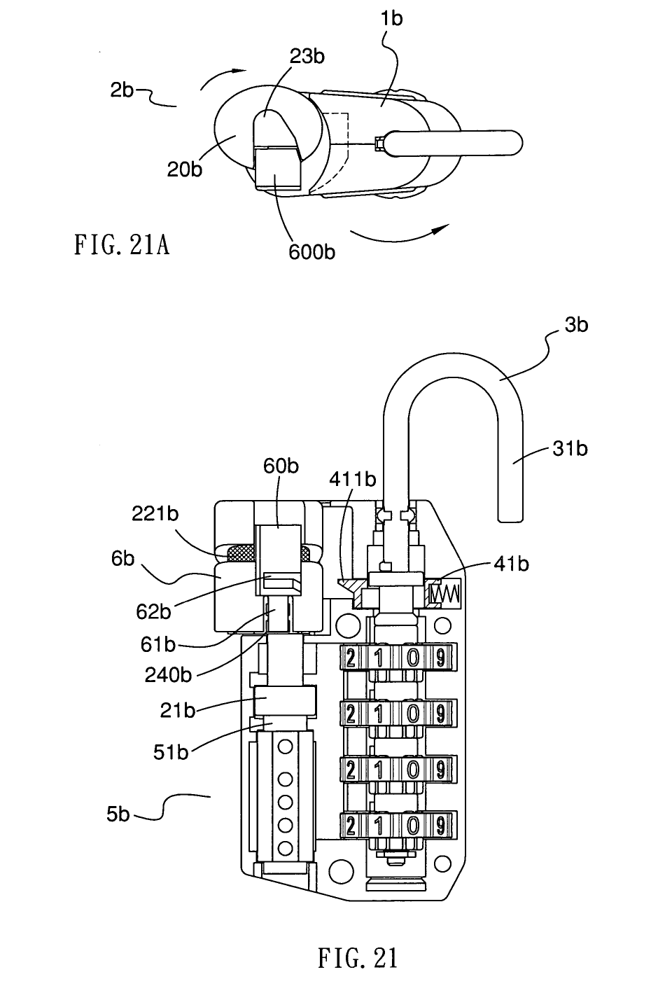

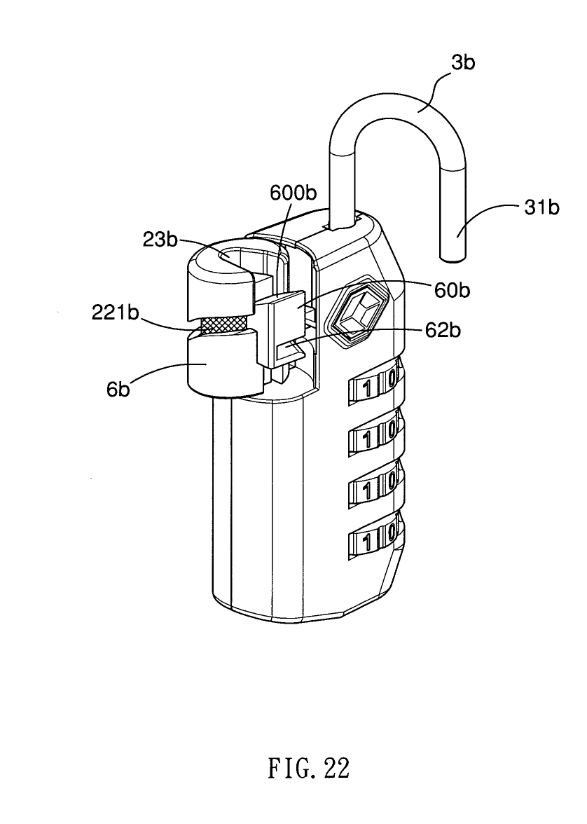

Referring to FIGS. 21, 21A and 22, the key lock module 5b is rotated by a specified key to drive the base portion 21b which rotates the limit knob 20b to reach an opened position, so that the free section 31b of the shackle 3b is rotatable to enter into or detach from the receiving recess 23b. When the limit knob 20b is rotated to reach the opened position, the indicator 6b is rotated with the limit knob 20b to detach the locking groove 62b of the indicator 6b from the protruding latch 411b of the locking member 41b. At the time, when the free section 31b of the shackle 3b is rotated to detach from the receiving recess 23b, the end portion of the free section 31b is moved to push the tapered push face 600b of the slide 60b to move the indicator 6b downward, so that the elastic hook 61b is hooked in the lower positioning groove 240b. Accordingly, the second mark 221b is exposed outward and the first mark 220b is covered by the indicator 6b, so that the user can judge if the padlock has been unlocked by a specified key by exposure of the second mark 221b.

Thus, a user can understand movement of the indicator 6b by touch, so that the padlock is also available for the blind people.

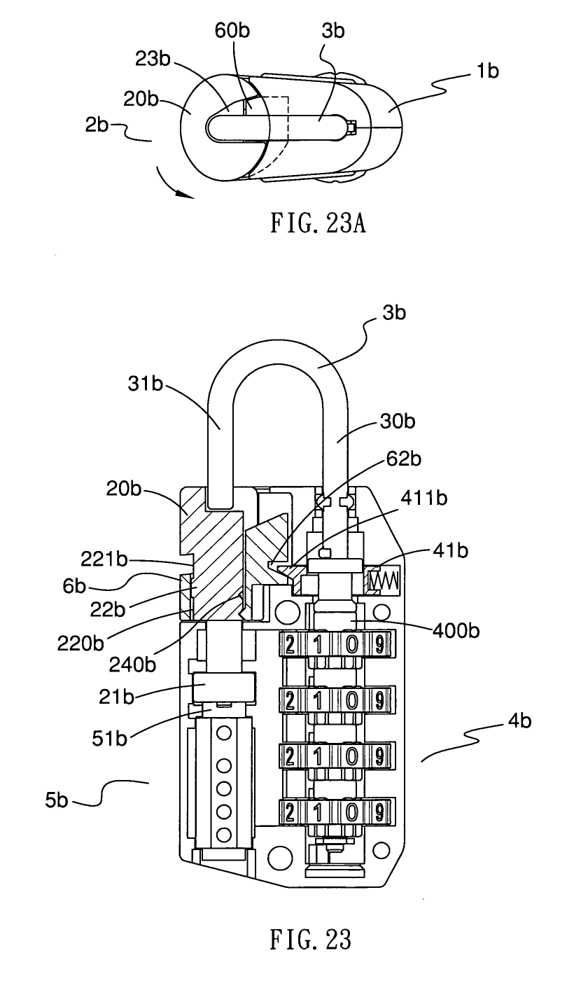

Referring to FIGS. 23 and 23A, when the limit knob 20b is rotated reversely by the key lock module 5b to move from the opened position to a closed position, the locking groove 62b of the indicator 6b is locked by the protruding latch 41 1b of the locking member 41b.

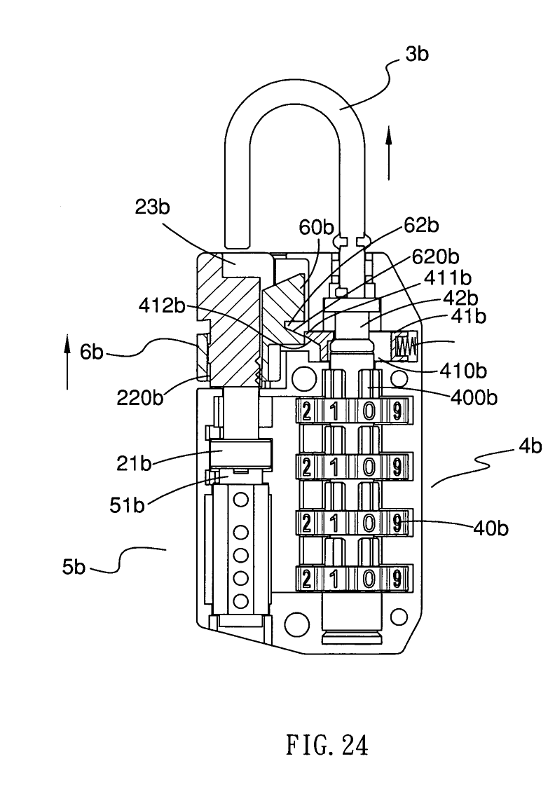

Referring to FIG. 24, the number wheel unit 40b is disposed at the unlocked state to unlock the shackle 3b and the shackle 3b is lifted to detach the free section 31b of the shackle 3b from the receiving recess 23b, the limit member 42b is pushed by the retractable shaft 400b to detach from the limit channel 410b, so that the locking member 41b is movable freely. Then, when the indicator 6b is pushed upward, the oblique face 412b of the protruding latch 411b slides on the guide face 620b of the locking groove 62b, so that the indicator 6b is moved sideward until the indicator 6b is returned to the first position where the first mark 220b is exposed outward.

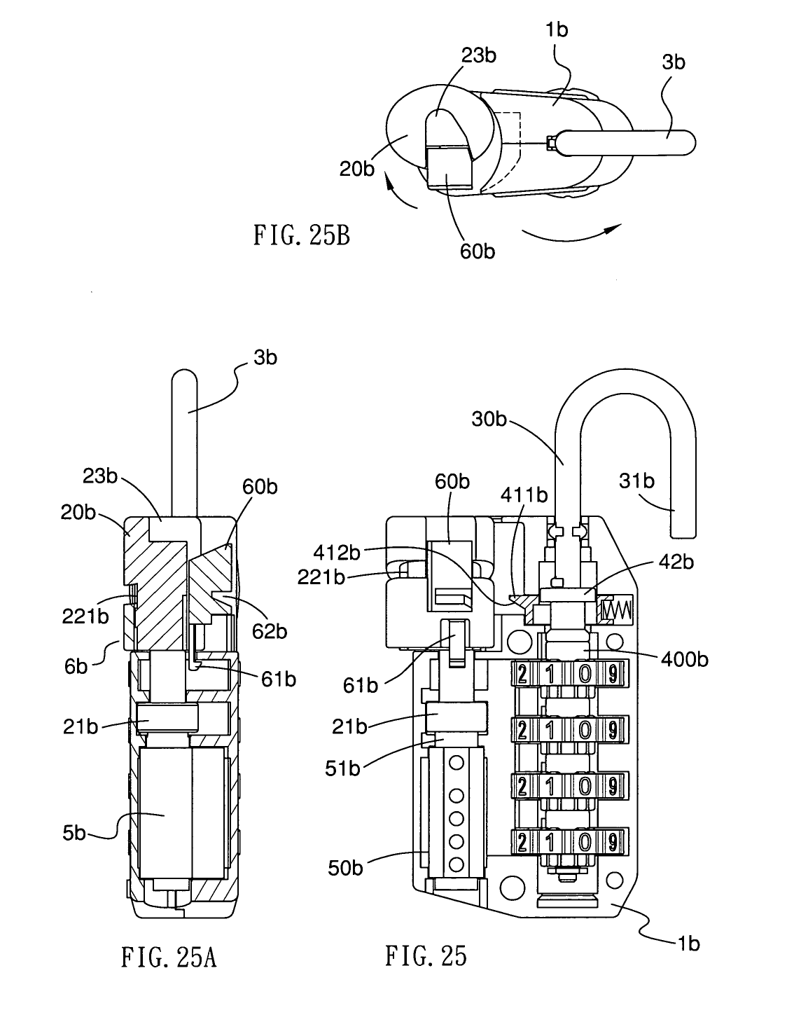

Referring to FIGS. 25-27, a padlock in accordance with the fourth preferred embodiment of the present invention is similar to that of the third preferred embodiment, wherein the difference is in that the elastic hook 61b of the fourth preferred embodiment is hooked outward, and the housing 1b has a passage 10b corresponding to the elastic hook 61b at the locked state.

As shown in FIGS. 25, 25A and 25B, when the indicator 6b is pushed downward to expose the second mark 221b, the elastic hook 61b is hooked on the housing 1b.

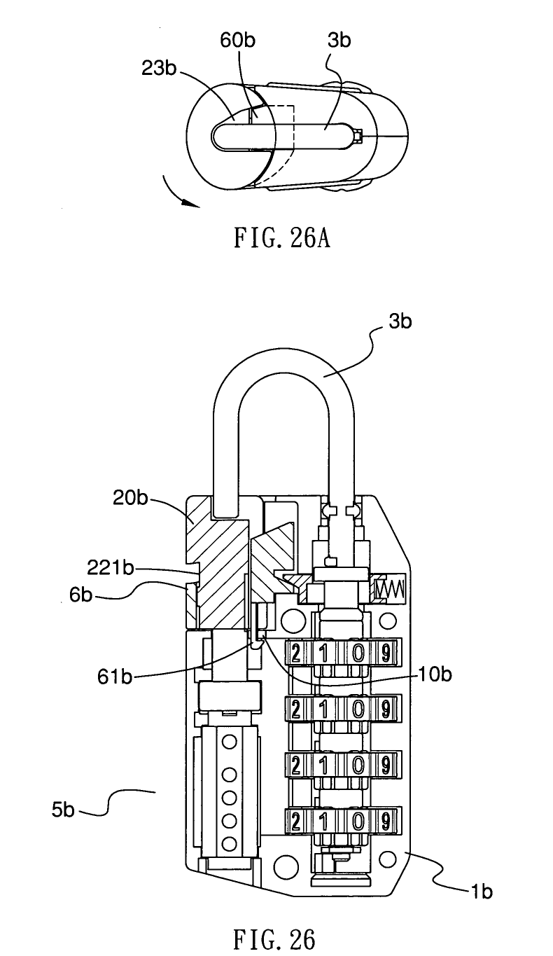

As shown in FIGS. 26 and 26A, when the limit knob 20b is rotated reversely by the key lock module 5b to move from the opened position to the closed position, the elastic hook 61b is aligned with the passage 10b of the housing 1b.

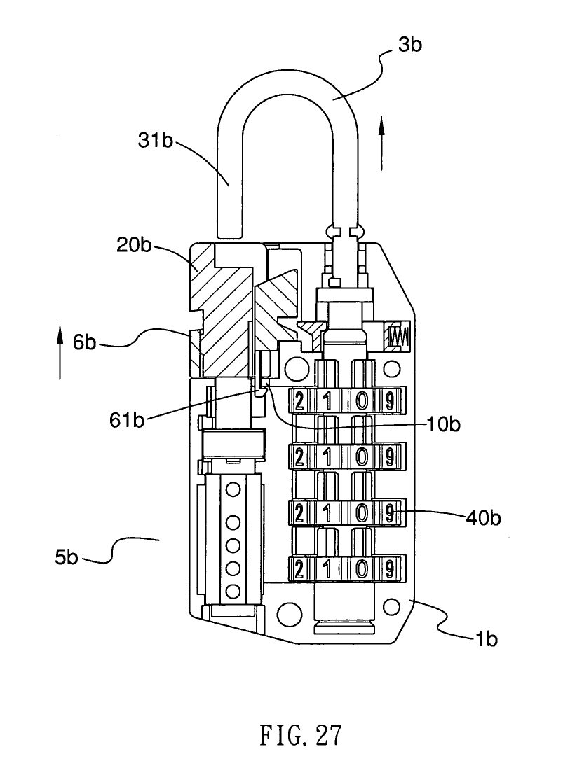

As shown in FIG. 27, when the number wheel unit 40b is disposed at the unlocked state and the indicator 6b is pushed upward, the elastic hook 61b is expanded through the passage 10b of the housing 1b.

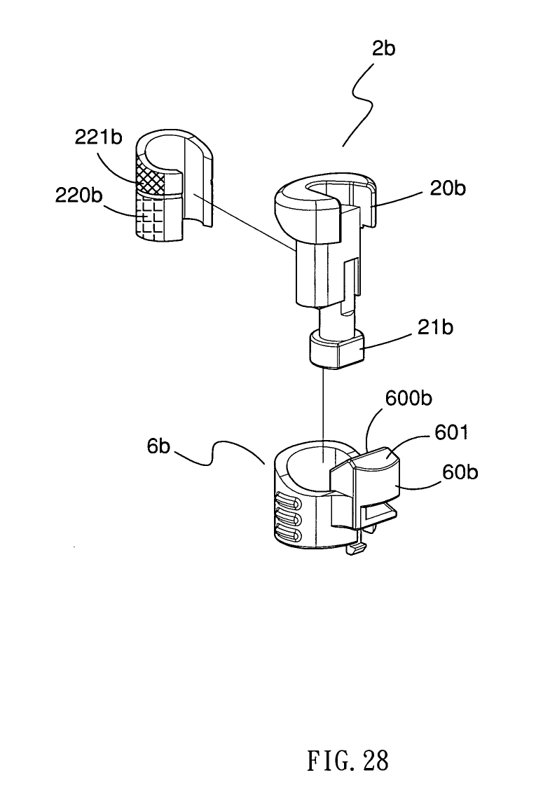

FIG. 28 also shows a catch member 2b and an indicator 6b of a padlock in accordance with the fifth preferred embodiment of the present invention, similarly to the catch member 2b and the indicator 6b of the fourth embodiment. As shown in FIG. 28, the catch member 2b includes a limit knob 20b and a base portion 21b extended from the bottom face of the limit knob 20b. The indicator 6b also has a side formed with a slide 60b with a tapered face 600b. Additionally, the slide 60b further has an inclined face 601 oppositely connected with the tapered face 600b of the slider 60b. In the fifth preferred embodiment, the tapered face 600b and the inclined face 601 are provided for assisting the indicator 6b in position precisely. Preferably, a first mark 220b and a second mark 221b of the fifth preferred embodiment are adhesively attached to or are clipped to the catch member 2b.

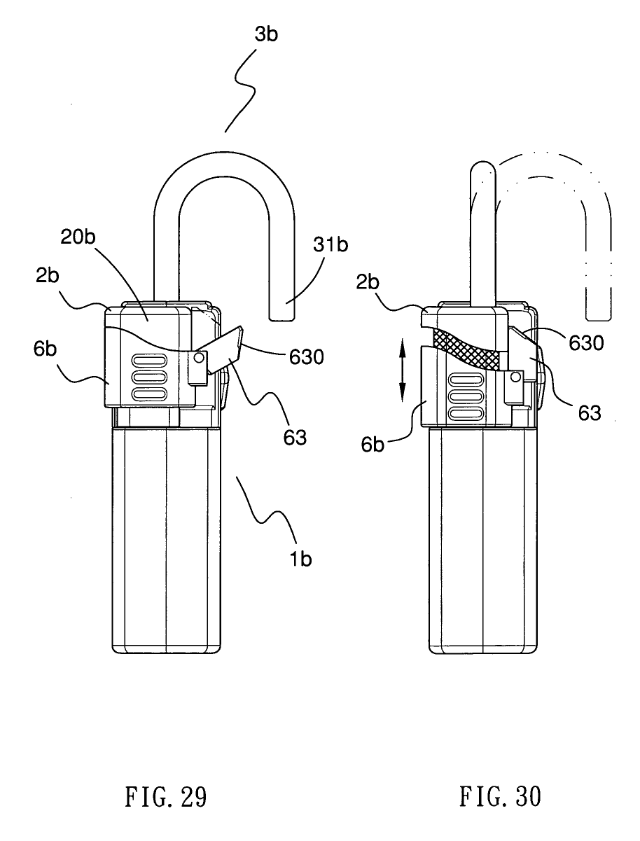

FIGS. 29-30 further show a padlock in accordance with the sixth preferred embodiment. Similarly to the foregoing embodiments, the padlock comprises a housing 1b, a catch member 2b, a shackle 3b, a locking mechanism, and an indicator 6b. The catch member 2b includes a limit knob 20b, which has a receiving recess having a first opening located at the top face of the limit knob 20b and a second opening located at the side face of the limit knob 20b, similarly to the limit knobs of the above embodiments. Additionally, the indicator 6b further has a block 63 pivoted elastically on the indicator 6b and facing to the second opening of the limit knob 20b. The block 63 has a top formed with a tapered face 630 inclined away from the second opening of the limit knob 20b. Differently to the above preferred embodiments, as shown in FIGS. 29-30, the indicator 6b is disposed st the second position only after the tapered face 630 of the block 63 is pushed by a free section 31b of the shackle 3b. More specifically, the block 63 blocks the second opening of the limit knob 20b when the indicator 6b is disposed at the first position. After the catch member 2b is moved by the locking mechanism, namely the key lock module as described in above embodiments, the free section 31b of the shackle 3b is capable of rotating away from the limit knob 20b by pushing the pivoted block 63, which is elastically returnable to its original position. Subsequently, when the free section 31b of the shackle 3b is moved back to the limit knob 20b, the free section 31b of the shackle 3b pushes the tapered face 630 of the returned block 63, and the indicator 6b is accordingly moved downwardly and disposed at the second position. Furthermore, the indicator 6b could be returned from the second position to the first position only when a number lock module of the locking mechanism is at the unlocked state.

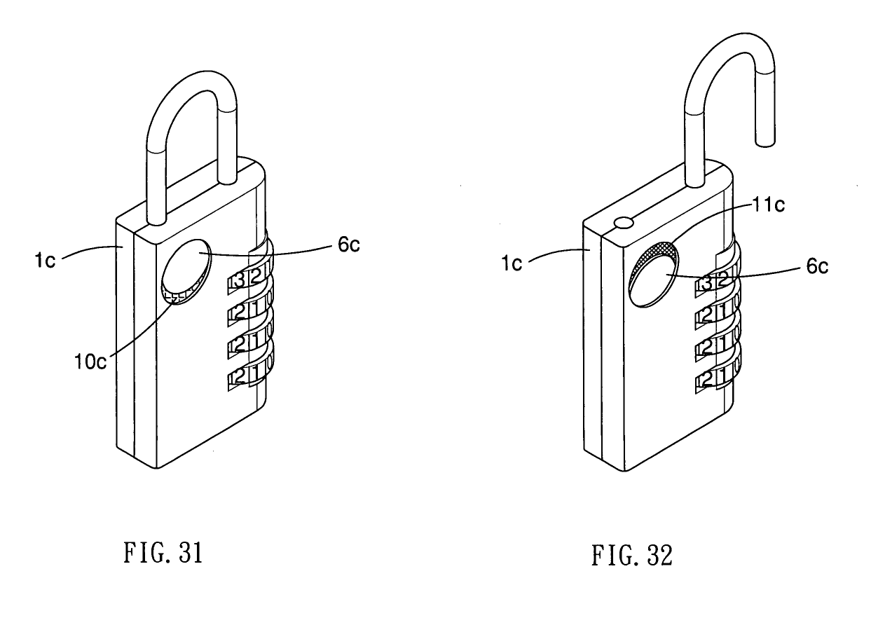

Referring to FIGS. 31 and 32, a padlock in accordance with the seventh preferred embodiment of the present invention is similar to that of the first preferred embodiment, wherein the difference is in that an indicator 6c is movably mounted on an outer face of the housing 1c. When the padlock is unlocked by a specified key, the indicator 6c is changed from a first position to a second position. In addition, the indicator 6c is returned from the second position to the first position only when the number lock module is disposed at the unlocked state. The housing 1c is formed with a first mark 10c and a second mark 11c. When the indicator 6c is disposed at the first position, the first mark 10c is exposed outward and the second mark 11c is covered by the indicator 6c. When the indicator 6c is disposed at the second position, the second mark 11c is exposed outward and the first mark 10c is covered by the indicator 6c. Thus, the user can judge if the padlock has been unlocked by inspecting movement of the indicator 6c. In addition, the first mark 10c and the second mark 11c are selected from either one of the group including character, figures, colors and signals.

Accordingly, in some preferred embodiments of the present invention, the limit knob has a window and movements of the limit knob is controlled by a key and the mating key lock module. The indicator is movably mounted in the respective limit knob and the indicator is changed from a first position to a second position by the limit knob, so that the first color and the second color of the indicator are exposed from the window respectively. In addition, the position of the indicator is changed in a lifting displacement manner or in a rotation displacement manner.

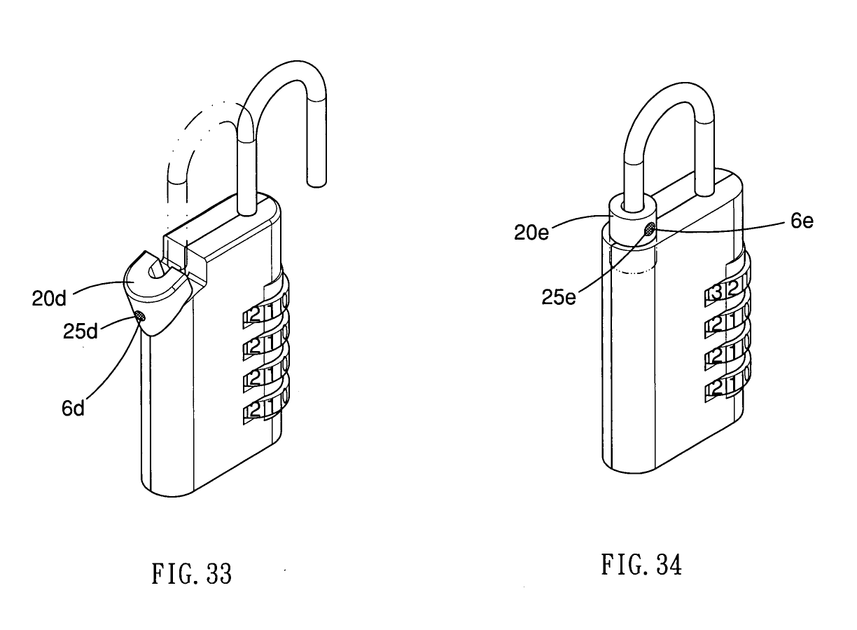

FIG. 33 shows the eighth preferred embodiment of the present invention. In the eighth preferred embodiment, the limit knob 20d has a window 25d and is rotatable in a swinging manner. Thus, the position of the indicator 6d mounted in the limit knob 20d is changed by the swinging rotation of the limit knob 20d, so that a user can see change of the position of the indicator 6d from the window 25d.

FIG. 34 shows the ninth preferred embodiment of the present invention. In the ninth preferred embodiment, the limit knob 20e has a window 25e and is movable upward and downward. Thus, the position of the indicator 6e mounted in the limit knob 20e is changed by displacement of the limit knob 20e, so that a user can see change of the position of the indicator 6e from the window 25e.

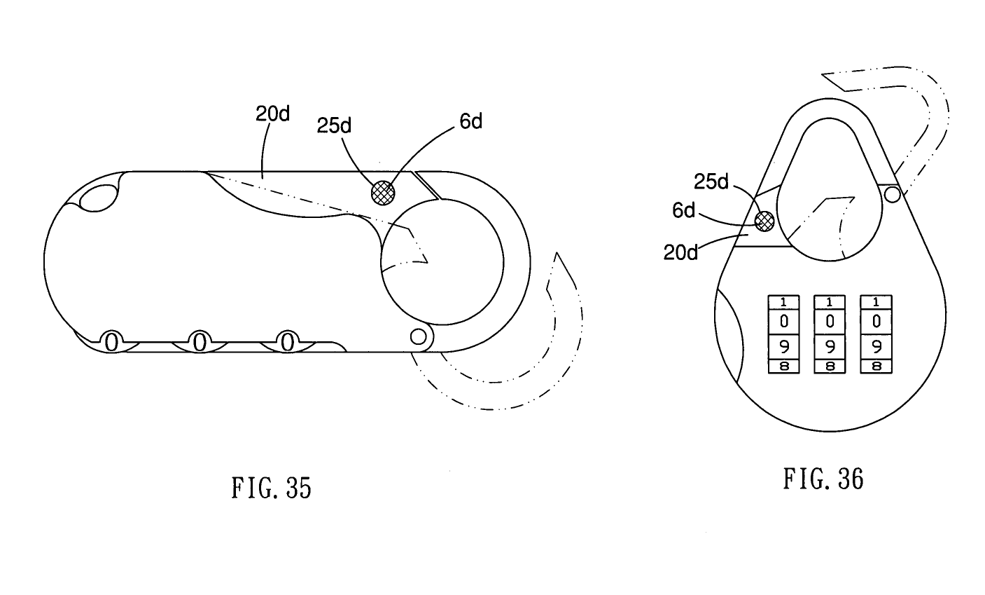

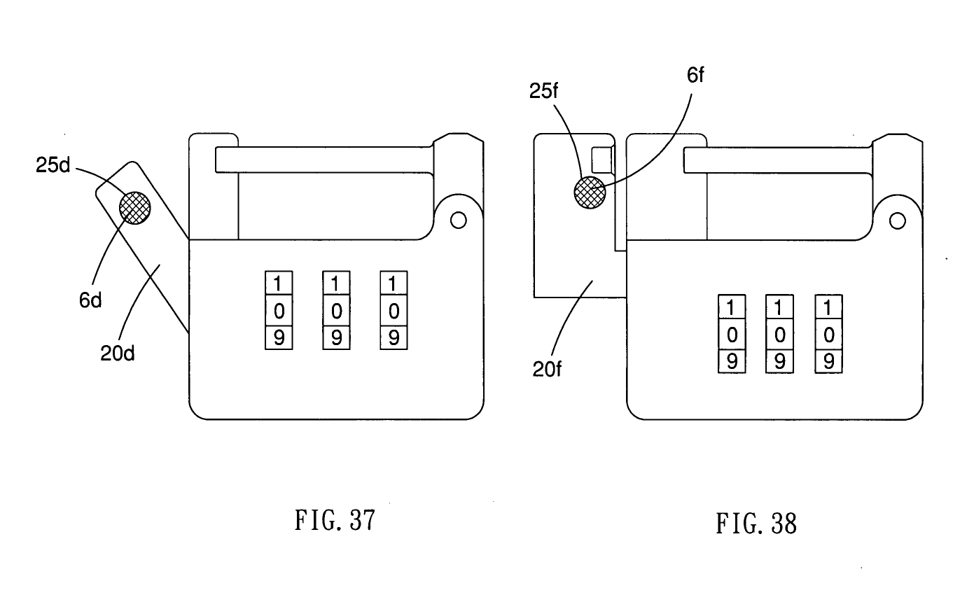

FIGS. 35-37 show the tenth preferred embodiment of the present invention. In the tenth preferred embodiment, the limit knob 20d is similar to that shown in FIG. 33, wherein the limit knob 20d is rotated in a swinging manner. Thus, the position of the indicator 6d mounted in the limit knob 20d is changed by the swinging rotation of the limit knob 20d, so that a user can see change of the position of the indicator 6d from the window 25d.

FIG. 38 shows the eleventh preferred embodiment of the present invention. In the eleventh preferred embodiment, the limit knob 20f has a window 25f and is movable in a horizontal manner. Thus, the position of the indicator 6f mounted in the limit knob 20f is changed by displacement of the limit knob 20f, so that a user can see change of the position of the indicator 6f from the window 25f.

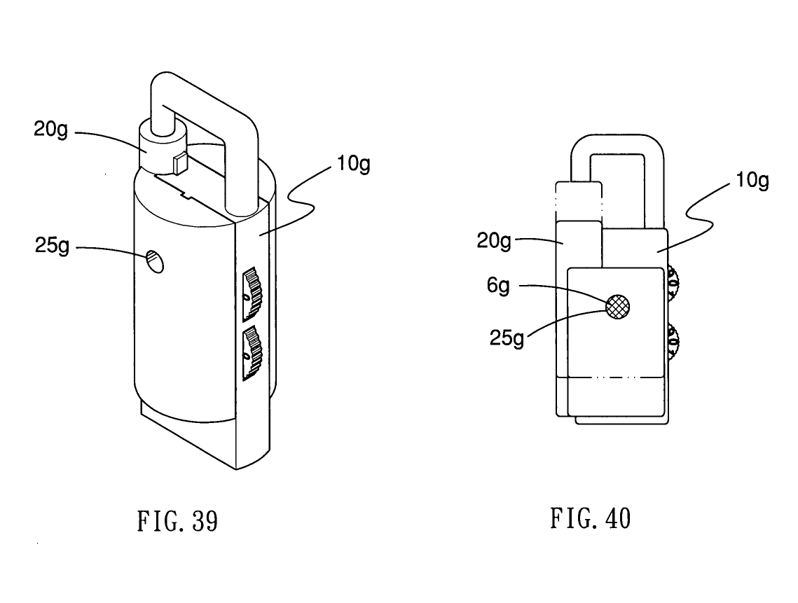

FIGS. 39 and 40 show the twelfth preferred embodiment of the present invention. In the twelfth preferred embodiment, the limit knob 20g is movable upward and downward on a lock body 10g and has a window 25g. Thus, the position of the indicator 6g mounted in the limit knob 20g is changed by displacement of the limit knob 20g, so that a user can see change of the position of the indicator 6g from the window 25g.

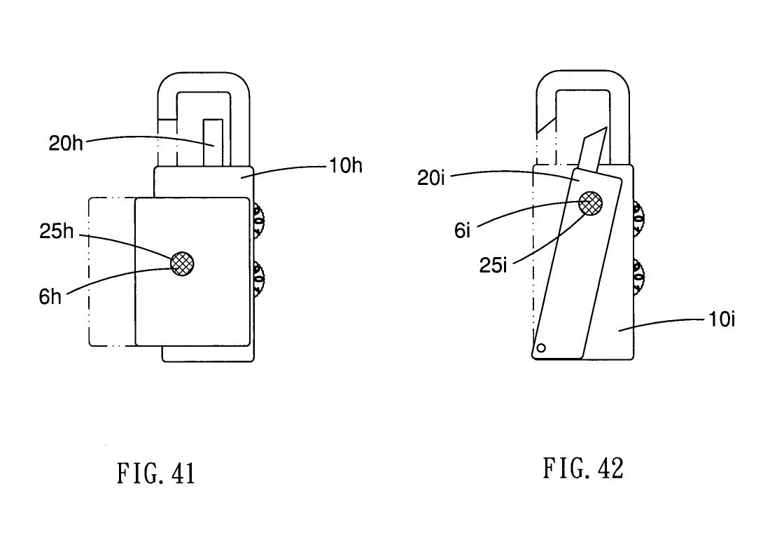

FIG. 41 shows the thirteenth preferred embodiment of the present invention. In the thirteenth preferred embodiment, the limit knob 20h is movable on a lock body 10h in a horizontal manner and has a window 25h. Thus, the position of the indicator 6h mounted in the limit knob 20h is changed by displacement of the limit knob 20h, so that a user can see change of the position of the indicator 6h from the window 25h.

FIG. 42 shows the fourteenth preferred embodiment of the present invention. In the fourteenth preferred embodiment, the limit knob 20i is rotatable on a lock body 10i in a swinging manner and has a window 25i. Thus, the position of the indicator 6i mounted in the limit knob 20i is changed by displacement of the limit knob 20i, so that a user can see change of the position of the indicator 6i from the window 25i.

Accordingly, the padlock is provided with a limit knob whose movement is controlled by a locking mechanism, so that when the limit knob is moved to an opened position, the shackle is rotated to detach from the limit knob. In addition, the limit knob is provided with an indicator which is moved with the limit knob from a first position to a second position, so that the user can judge if the padlock has been unlocked by inspecting movement of the indicator.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

What is claimed is:

1. A padlock, comprising:
a housing;
a catch member including a limit knob and a base portion extended from the limit knob to form a movable connection with the housing;
a shackle including a root section to form a movable connection with the housing, and a free section extended from the root section and entered into the limit knob;
a locking mechanism mounted in the housing and including:
a number lock module connected with the root section of the shackle and arranged to allow rotation of the root section of the shackle, wherein when the number lock module is disposed at an unlocked state, the number lock module allows the shackle to move with displacement of the root section; and
a key lock module connected with the base portion of the catch member and driven by a key which is rotated to drive the base portion of the catch member so as to control movement of the catch member;
an indicator movably mounted on the limit knob and changed from a first position to a second position according to movement of the limit knob, wherein the indicator is returned from the second position to the first position only when the number lock module is disposed at the unlocked state.

2. The padlock in accordance with claim 1, wherein the limit knob of the catch member has a receiving recess for receiving the free section of the shackle.

3. The padlock in accordance with claim 2, wherein the receiving recess has a first opening located at a top face of the limit knob and a second opening located at a side face of the limit knob and communicating with the first opening, so that when the second opening is moved from a closed position to an opened position by rotating the limit knob, the free section of the shackle is rotatable to detach from or to enter the receiving recess of the limit knob via the second opening.

4. The padlock in accordance with claim 3, wherein the housing has a recessed space to receive the limit knob, and the space has a height at least equal to that of the limit knob.

5. The padlock in accordance with claim 1, wherein:
the limit knob has an inside formed with a receiving chamber and a side face formed with a window connected to the receiving chamber; and
the indicator is movably mounted in the receiving chamber of the limit knob and has a surface provided with a first mark and a second mark so that when the indicator is disposed at the first position, the first mark is exposed from the window, and when the indicator is disposed at the second position, the second mark is exposed from the window.

6. The padlock in accordance with claim 3, wherein:
the limit knob has an inside formed with a receiving chamber and a side face formed with a window connected to the receiving chamber; and
the indicator is mounted in the receiving chamber of the limit knob in a lifting manner and has a surface provided with a first mark and a second mark so that when the indicator is disposed at the first position, the first mark is exposed from the window, and when the indicator is disposed at the second position, the second mark is exposed from the window.

7. The padlock in accordance with claim 5, wherein the limit knob of the catch member has a receiving recess for receiving the free section of the shackle and the receiving recess of the limit knob has a bottom formed with a setting hole connected to the receiving chamber, and when the free section of the shackle is received in the receiving recess of the limit knob, the setting hole is covered by the free section of the shackle.

8. The padlock in accordance with claim 6, wherein:
the receiving recess of the limit knob has a bottom formed with a setting hole connected to the receiving chamber, and when the free section of the shackle is received in the receiving recess of the limit knob, the setting hole is covered by the free section of the shackle;
the housing has a ramp corresponding to a bottom face of the limit knob; and
the indicator has a first side formed with a protruding shaft extended into the setting hole of the limit knob and a second side formed with a guide block rested on the ramp of the housing.

9. The padlock in accordance with claim 6, wherein:
the limit knob includes a limit block and a drive block connected with the limit block, the receiving recess being located in the limit block and the window being located in the drive block, wherein the receiving recess has a bottom formed with a setting hole, the drive block has a bottom formed with a curved slot, the limit block has a bottom formed with a locking block;
the indicator has a sector-shaped slideway, a protruding shaft and a guide block, the slideway having an end formed with an insertion groove having a greater depth, the guide block having a bottom formed with a first ramp, wherein when the indicator is mounted in the limit knob, the locking block is slidable in the slideway, the protruding shaft is extended into the setting hole, and the guide block is extended through the curved slot;
the housing has a second ramp having a downward oblique end and a third ramp having a downward oblique end connected with the downward oblique end of the second ramp, wherein the second ramp has an outer end lower than an outer end of the third ramp, and the first ramp of the guide block contacts the third ramp of the housing.

10. The padlock in accordance with claim 3, wherein the indicator is slidably mounted on the limit knob in a lifting manner and rotatable with the limit knob, so that when the free section of the shackle is detached from the receiving recess of the limit knob through the second opening, the indicator is pushed by the free section of the shackle to the second position.

11. The padlock in accordance with claim 4, wherein the indicator is slidably mounted on the limit knob in a lifting manner and rotatable with the limit knob, so that when the free section of the shackle is detached from the receiving recess of the limit knob through the second opening, the indicator is pushed by the free section of the shackle to the second position.

12. The padlock in accordance with claim 10, wherein the indicator has a surface provided with a first mark and a second mark so that when the indicator is disposed at the first position, the first mark is exposed from the window and the second mark is covered by the indicator, and when the indicator is disposed at the second position, the second mark is exposed from the window and the first mark is covered by the indicator.

13. The padlock in accordance with claim 1 1, wherein the indicator has a surface provided with a first mark and a second mark so that when the indicator is disposed at the first position, the first mark is exposed from the window and the second mark is covered by the indicator, and when the indicator is disposed at the second position, the second mark is exposed from the window and the first mark is covered by the indicator.

14. A padlock, opened by either one of a key and a code, comprising an indicator mounted on the padlock in a movable manner, wherein when the padlock is opened by the key, the indicator is moved from a first position to a second position; and the indicator is returned from the second position to the first position only when the padlock is opened by the code; and wherein the indicator has a surface provided with a first mark and a second mark so that when the indicator is disposed at the first position, the first mark is exposed and the second mark is covered by the indicator, and when the indicator is disposed at the second position, the second mark is exposed and the first mark is covered by the indicator.

15. A padlock, comprising:
a housing;
a catch member including a limit knob and a base portion extended from the limit knob to form a movable connection with the housing, the base portion has an exposed section located between the limit knob and the housing;
a shackle including a root section to form a movable connection with the housing, and a free section extended from the root section and entered into the limit knob;
a locking mechanism mounted in the housing and including:
a number lock module connected with the root section of the shackle and arranged to allow rotation of the root section of the shackle, wherein when the number lock module is disposed at an unlocked state, the number lock module allows the shackle to move with displacement of the root section; and
a key lock module connected with the base portion of the catch member and driven by a key which is rotated to drive the base portion of the catch member so as to control movement of the catch member;
an indicator movably mounted on an outer face of the exposed section and changed from a first position to a second position when the free section of the shackle is rotatable, wherein the indicator is returned from the second position to the first position only when the number lock module is disposed at the unlocked state.

16. The padlock in accordance with claim 15, wherein the exposed section has a surface provided with a first mark and a second mark so that when the indicator is disposed at the first position, the first mark is exposed and the second mark is covered by the indicator, and when the indicator is disposed at the second position, the second mark is exposed and the first mark is covered by the indicator.

17. The padlock in accordance with claim 15, wherein:
the limit knob of the catch member has a receiving recess having a first opening located at a top face of the limit knob and a second opening located at a side face of the limit knob;
the free section of the shackle is extended into the receiving recess to form a closed state;
the exposed section has a side formed with a slideway extended into the second opening of the limit knob and the slideway having two positioning grooves thereon;
the indicator has a slide and an elastic hook, the slide is slidable in the slideway so that when the indicator is disposed at the first position, the slide is slidingly to seal the second opening and the elastic hook is hooked on an upper positioning groove of the two positioning grooves, and when the indicator is disposed at the second position, the slide is retracted into the slideway and the elastic hook is hooked on a lower positioning groove of the two positioning grooves, wherein the slide has a top formed with a tapered push face inclined toward the second opening of the limit knob and provided for an end portion of the free section of the shackle to push thereto.

18. The padlock in accordance with claim 15, wherein:
the limit knob of the catch member has a receiving recess having a first opening located at a top face of the limit knob and a second opening located at a side face of the limit knob;
the free section of the shackle is entered into the receiving recess to form a closed state;
the exposed section has a side formed with a slideway extended into the second opening of the limit knob;
the indicator has a slide and an elastic hook, the slide is slidable in the slideway so that when the indicator is disposed at the first position, the slide is slidingly to seal the second opening, and when the indicator is disposed at the second position, the slide is retracted into the slideway and the elastic hook is hooked on the housing, wherein the slide has a top formed with a tapered push face inclined toward the second opening of the limit knob and provided for an end portion of the free section of the shackle to push thereto; and
the housing has a passage, and when the limit knob is disposed at the closed state, the elastic hook is aligned with and extended through the passage, and when the limit knob is disposed at an opened state, the elastic hook is separated from the passage.

19. The padlock in accordance with claim 17, wherein the slide has a locking groove having a bottom face formed with a tapered guide face inclined downward, and the number lock module includes a number wheel unit, a locking member, and a limit member, wherein:
the number wheel unit has a retractable shaft;
the locking member has a limit channel and has a first side formed with a protruding latch that can be locked in the locking groove, the protruding latch has a bottom face formed with an oblique face corresponding to the guide face, the locking member has a second side provided with an elastic member located opposite to the protruding latch and urged on the housing; and
the limit member is mounted on the root section of the shackle, wherein when the number wheel unit is disposed at a locked state to lock the shackle, the limit member is received in the limit channel by the root section of the shackle, so that the locking member is not movable, and when the number wheel unit is disposed at the unlocked state to unlock the shackle, the limit member is pushed by the retractable shaft to detach from the limit channel, so that the locking member is movable freely.

20. The padlock in accordance with claim 18, wherein the slide has a locking groove having a bottom face formed with a tapered guide face inclined downward, and the number lock module includes a number wheel unit, a locking member, and a limit member, wherein:
the number wheel unit has a retractable shaft;
the locking member has a limit channel and has a first side formed with a protruding latch that can be locked in the locking groove, the protruding latch has a bottom face formed with an oblique face corresponding to the guide face, the locking member has a second side provided with an elastic member located opposite to the protruding latch and urged on the housing;
the limit member is mounted on the root section of the shackle, wherein when the number wheel unit is disposed at a locked state to lock the shackle, the limit member is received in the limit channel by the root section of the shackle, so that the locking member is not movable, and when the number wheel unit is disposed at the unlocked state to unlock the shackle, the limit member is pushed by the retractable shaft to detach from the limit channel, so that the locking member is movable freely.
